(19) United States
(12) Patent Application Publication
(10) Pub. No.: US 2026/0264819 A1
(43) Pub. Date: Sep. 10, 2026

(54) APPARATUS AND METHODS FOR SHIP PROPELLER SHAFT REMOVAL

(71) Applicant: Vigor Industrial LLC, Portland, OR (US)

(72) Inventors: Scott Fischer, Portland, OR (US); Jonathan Donahue, Seattle, WA (US)

(73) Assignee: Vigor Industrial LLC, Portland, OR (US)

(21) Appl. No.: 19/073,634

(22) Filed: Mar. 7, 2025

(51) Int. Cl. B63B 85/00; B23P 19/02; B63H 23/34

(52) U.S. Cl. CPC B63B 85/00; B63H 23/34; B23P 19/022; B23P 19/025

(57) ABSTRACT

A shaft support assembly for removing a propeller shaft from a ship can include an insert portion and a frame portion. The insert portion can move along an axis of motion relative to the frame portion. A mechanical lifting device can be disposed within insert portion. A cradle can be coupled to an upper side portion of the insert portion and configured to receive and support a propeller shaft. An adjustment portion may be included and can allow the cradle to rotate about a rotational axis and/or to translate in a direction parallel to the axis.

### FIELD

The present disclosure relates to apparatus and methods for removing propeller shafts from ships.

### BACKGROUND

Ships are often subjected to harsh operating conditions and corrosive environments. Operating in sea water and in proximity to saltwater spray can create a reoccurring need for preservation efforts. Ship propeller shafts are often removed during drydocking periods as a part of the maintenance of the ship. Removing the propeller shafts allows thorough inspection and maintenance of the propeller shaft, shaft seals, bearings, and other components that can wear down over time due to constant exposure to seawater, allowing for necessary repairs like replacing worn bushings or seals without the limitations of being afloat. Periodically removing the propeller shafts over the lifecycle of a ship is particularly important to prevent water leaks into the engine room and maintain the vessel's operational efficiency.

### SUMMARY

Described herein are propeller shaft removal apparatuses and methods of use. The propeller shaft removal apparatuses can for example provide quicker and safer removal of propeller shafts. As such, the propeller shaft removal apparatuses and methods of use disclosed herein can, among other things, overcome one or more of the deficiencies of typical propeller shaft removal methods.

In some examples, a shaft support assembly for removing a propeller shaft from a ship, the shaft support assembly comprises: a vertical axis of motion; a jack member disposed along the vertical axis of motion and comprising a main body and a hydraulic ram, wherein the hydraulic ram extends along the vertical axis of motion; an insert portion coupled to the hydraulic ram and extending over the jack member when the ram is in a retracted position within the main body; a cradle coupled to an upper side portion of the insert portion; and a frame disposed around the insert portion and the jack member and configured to support the insert portion wherein the insert portion and the frame are configured to protect the jack member from lateral loading during relative motion between the insert portion and the frame.

In some examples, the insert portion has radially externally facing mating features and wherein the frame has radially internally facing mating features which are configured to receive the radially externally facing mating features of the insert portion. In some examples, the jack member is rated at greater than 75 tons. In some examples, the cradle is configured to rotate about a rotational axis, wherein the rotational axis is orthogonal to the vertical axis of motion. In some examples, the cradle is configured to move laterally along an axis, wherein the axis is orthogonal to the vertical axis of motion.

In some examples, a system for removing a propeller shaft from a ship, the system comprises: one or more shaft support assemblies; and a vehicle configured to carry a propeller shaft, wherein the one or more shaft support assemblies are disposed along a length of the vehicle. In some examples, the one or more shaft support assemblies comprises three shaft support assemblies. In some examples, the system from removing a propeller shaft further comprises one or more height adjustment stands configured to adjust the height of the one or more shaft support assemblies.

In some examples, a shaft support assembly for removing a propeller shaft from a ship, the shaft support assembly comprises: an axis of motion; an insert portion configured to be coupled to a mechanical lifting device and to extend over the mechanical lifting device when the mechanical lifting device is in a retracted position; and a frame disposed around the insert portion and configured to support the insert portion, wherein the insert portion and the frame are configured to protect a mechanical lifting device from lateral loading during relative motion between the insert portion and the frame.

In some examples, the insert portion comprises radially externally facing mating features and wherein the frame has radially internally facing mating features which are configured to receive the radially externally facing mating features of the insert portion. In some examples, the shaft support assembly further comprises a mechanical lifting device disposed within an internal cavity of the insert portion and disposed along the axis of motion. In some examples, the mechanical lifting device is hydraulic cylinder comprising a main body and a hydraulic ram, wherein the hydraulic ram is coupled to the insert portion and extends along the axis of motion. In some examples, a cradle is coupled to the insert portion. In some examples, the cradle is configured to rotate about a rotational axis, wherein the rotational axis is orthogonal to the axis of motion. In some examples, the cradle is configured to move laterally along an axis, wherein the axis is orthogonal to the axis of motion.

In some examples, a method for removing a propeller shaft from a ship comprises: attaching a first shaft support assembly and a second shaft support assembly to a propeller shaft; and retracting the propeller shaft by moving the first shaft support assembly and the second shaft support assembly in a direction which withdraws the propeller shaft from the ship. In some examples, the method further comprises attaching a third shaft support assembly to the propeller shaft and disengaging the first shaft support assembly. In some examples, the method comprises withdrawing the propeller shaft from an external strut after disengaging the first shaft support assembly. In some examples, the method comprises comprising using the first shaft support assembly and the second shaft support assembly to position the propeller shaft as required while withdrawing the propeller shaft from the ship. In some examples, the method comprises using an adjustment portion to adjust a position of a cradle portion before attaching the first shaft support assembly and the second shaft support assembly to the propeller shaft.

The foregoing and other objects, features, and advantages of the disclosed technology will become more apparent from the following detailed description, which proceeds with reference to the accompanying figures.

### BRIEF DESCRIPTION OF THE DRAWINGS

FIGS. 1A-1B depict aspect views of a shaft support assembly for removing a propeller shaft from a ship in the extended and retracted positions.

FIGS. 1C-1D depict a top view and a side view of the shaft support assembly of FIGS. 1A-1B.

FIG. 2 depicts a double-acting hydraulic cylinder which can be used with the shaft support assembly of FIGS. 1A-1B in some examples.

FIG. 3 depicts a height adjustment stand for elevating the shaft support assembly of FIGS. 1A-1B.

FIG. 4 depicts side views of the shaft support assembly on of FIGS. 1A-1B in use with height adjustment stands similar to the height adjustment stand depicted in FIG. 3.

FIG. 5 depicts three of the shaft support assemblies of FIGS. 1A-1B positioned on a vehicle in a system for removing a propeller shaft from a ship.

FIGS. 6A-6E depict the system of FIG. 5 in use on ship including an external shaft and a support strut.

FIGS. 7A-7C depict a shaft support assembly for removing a propeller shaft from a ship according to another example.

### DETAILED DESCRIPTION

### General Considerations

For purposes of this description, certain aspects, advantages, and novel features of examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

As used herein, the term “forward” refers to the front of a vehicle, for example, on a ship the direction of the bow. The term “aft” refers to the rear of a vehicle, for example on a ship the direction of the stern. The term “inboard” referrers to the direction toward the center line of a vehicle or ship. The term “outboard” referrers to the direction away from the center line of a vehicle or ship. The term “starboard” refers to the side of a vehicle, such as a ship, that is on the right when one is facing forward. The term “port” refers to the side of a vehicle, such as a ship, that is on the left when one is facing forward.

As used herein, “e.g.” means “for example,” and “i.e.” means “that is.”

### Examples of the Disclosed Technology

Removing a ship's propeller shaft can be time consuming, require careful coordination, and support of heavy loads. In the past this has been accomplished using complicated rigging setups which can require chain falls and other rigging apparatus. These rigging setups can require welding connection points to the hull of the ship. This process is labor insive, time consuming, and often presents logistical challenges. In some cases, the procedures surrounding removing a propeller shaft can cost a shipyard days, if not weeks, of production time. Therefore, there exists a need for an apparatus and method of removing a ship's propeller shaft be easily and quickly installed to expedite preservation activities.

The current disclosure is directed to shaft support assemblies which can be used with mechanical lifting device, such as hydraulic jacks, to support the propeller shaft as it is withdrawn from the ship and methods of removing a propeller shaft from a ship. The shaft support apparatuses described herein can have the advantages of saving time and money. They can also improve the safety of the propeller shaft removal process. The shaft support assemblies and methods described herein can reduce setup and breakdown times and provide schedule improvements, in some instances from 2 weeks down to 1-2 days. In some examples, the shaft support assemblies described herein can further have the advantage of more evenly supporting the shaft during removal. In some examples, the apparatus described herein can have a weight capacity of seventy-five tons or more. The shaft support assemblies can have a dynamically adjustable height which has the advantage of giving users the ability to pull both horizontal and angled shafts. The design of the apparatuses described herein means that they can have the advantages of being low cost to construct and easy to maintain. The apparatus described herein can be modular and easily movable using machinery already available in a shipyard environment, for example, forklifts.

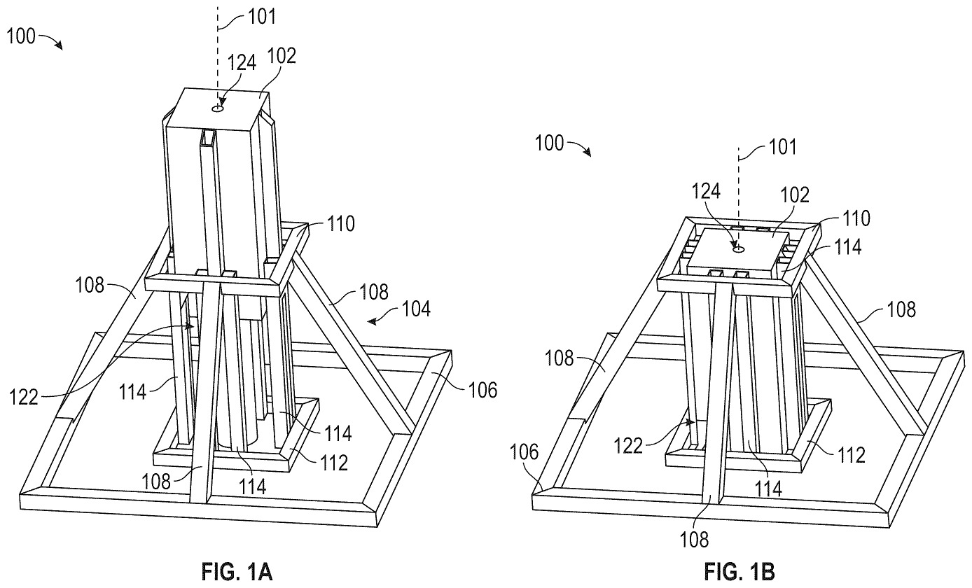

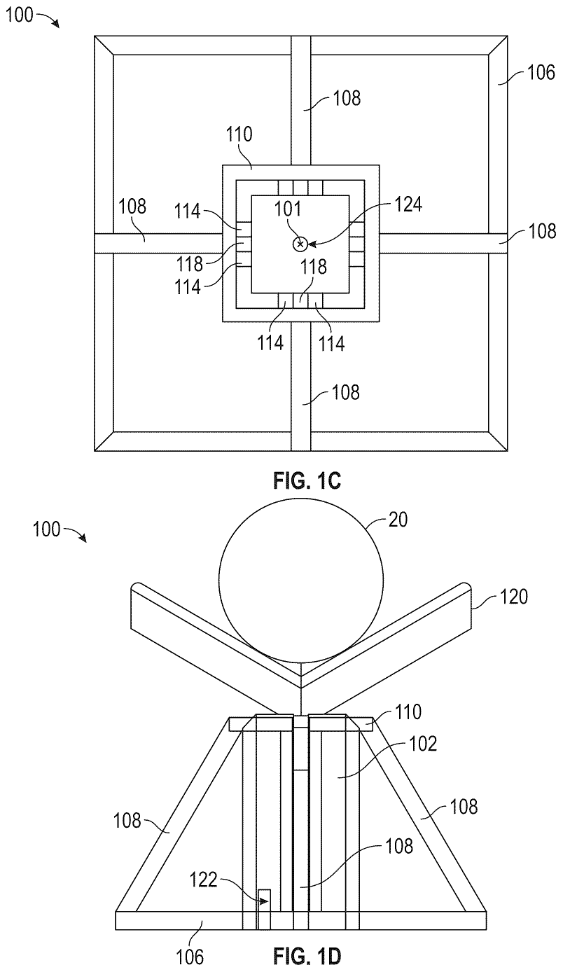

FIGS. 1A-1B depict a shaft support assembly 100 for removing a propeller shaft from a ship. FIG. 1A depicts the shaft support assembly 100 in an extended position and FIG. 1B depicts the shaft support assembly 100 in a retracted position. The shaft support assembly 100 can comprise an insert portion 102 and a frame portion 104. The frame portion 104 can be disposed around insert portion and configured to support the insert portion and can provide protection from lateral loading forces on the insert portion 102. The insert portion 102 can be configured to slide along an axis of motion 101 (also referred to as a “vertical axis of motion”) relative to the frame portion 104, for example, the insert portion 102 can slide up and down relative to the frame portion 104.

As depicted in FIGS. 1A-1B, the frame portion 104 can have a base portion and one or more struts which can extend from the base portion to a first support element. A second support element can be positioned in the same plane as the base portion. In the example depicted in FIGS. 1A-1D, the base portion 106 comprises a square disposed around the axis of motion 101 and four struts 108 which are coupled between the base portion 106 and a first support portion 110 which is positioned around the axis of motion 101. The struts are angle inward from the base portion 106 to the first support portion 110 such that they create a pyramid shape which can have the advantage of making the frame portion 104 more sturdy and less susceptible to tipping. A second support portion 112 can be positioned axially offset, along the axis of motion 101, from the first support portion 110. In the depicted example, the second support portion 112 is positioned within the same plane as the base portion 106. In some examples, there may also be a base plate, not depicted, that covers the area within the base portion 106 and the second support portion 112. The frame portion 104 may comprise steel, such as a steel beam.

The frame 104 may comprise one or more inwardly facing mating elements which can mate with outwardly facing mating elements disposed on the insert portion 102. These mating elements can allow relative motion between the frame portion 104 and the insert portion 102 along the axis of motion 101 but can help prevent lateral loading and/or twisting between the frame portion 104 and the insert portion 102. The frame 104 may comprise one or more inwardly facing mating elements disposed between first support portion 110 and the second support portion 112. In the depicted example, the mating elements comprises a plurality of inwardly facing rails 114 extending from first support portion 110 to the second support portion 112. The rails 114 can form slots into which mating elements disposed on the radially outward facing portion of the insert portion 102 can fit, for example the projections 118. In some examples, the mating elements may be lubricated to allow for ease of motion, for example, lubrication may be applied between the rails 114 and the projections 118. In some examples, the rails 114 and/or the projection 118 may comprise a layer of material configured to reduce friction and/or increase robustness between the rails 114 and the projection 118 (this layer is described below for the rails 514).

The insert portion 102 can slide along an axis of motion relative to the frame portion 104 and can have an internal cavity which is configured to receive a mechanical lifting device, such as a hydraulic cylinder. In the depicted example, the insert portion 102 comprises a box with outwardly facing mating elements and an internal cavity. The external portion of the box can be configured to fit within the frame portion 104 and slide along the axis of motion 101 relative to the frame portion 104. The insert portion 102 can comprise externally facing mating elements, such as the projections 118, which can be configured to interface with inwardly facing mating elements on the frame portion 104. The insert portion 102 can comprise one or more features for interfacing with other components. In some examples, the insert portion 102 can comprise a hole 124 on a top surface which can be used to attach a cradle 120. In some examples, the insert portion can comprise one or more openings or windows for access to the inner cavity. In the depicted example, a window 122 can allow hydraulic lines to pass through to the inner cavity. The insert portion 102 may comprise steel, such as a steel plates.

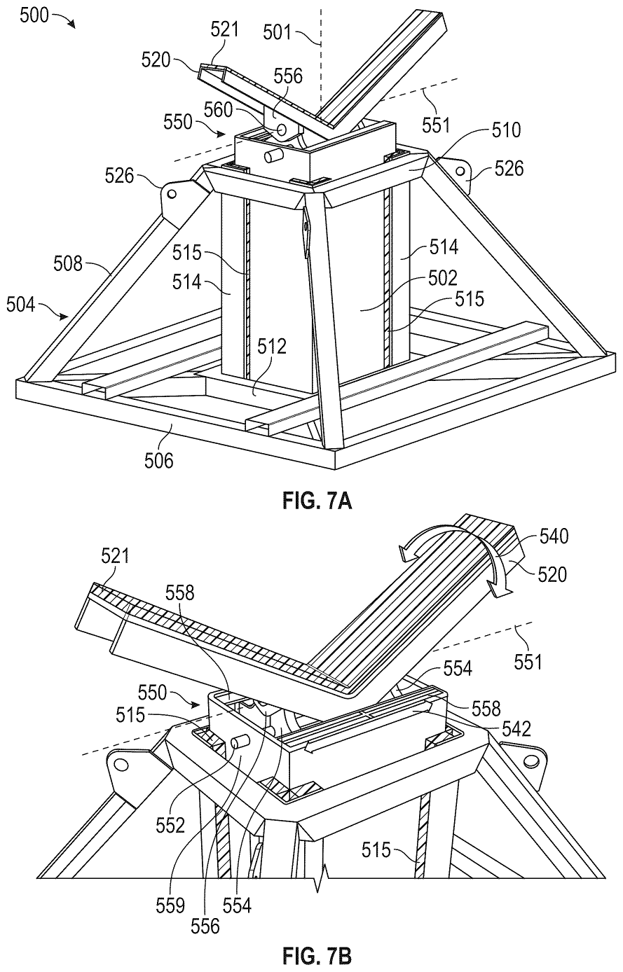

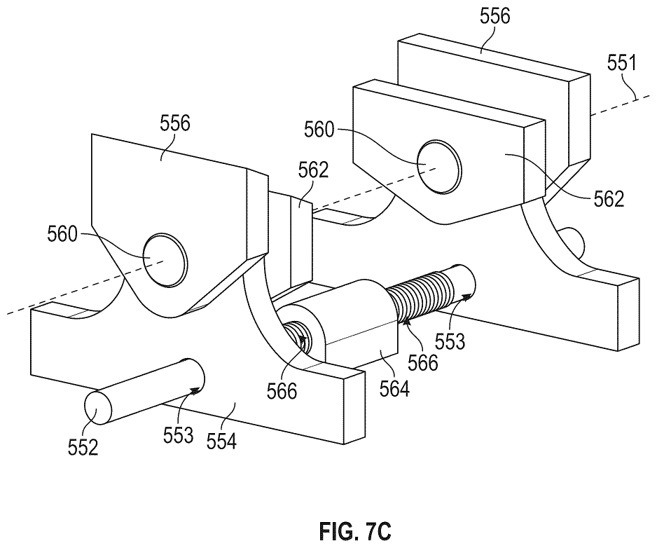

FIG. 1D depicts the cradle 120 positioned at the top of the shaft support assembly 100. The cradle 120 can be coupled to an upper side portion of the insert portion 102 and can be configured to receive and support a propeller shaft 20. In the depicted example, the cradle 120 is a “V” shape, but in some examples, the cradle 120 may comprise a “U” shape or a support portion with a capture member. The cradle 120 may be used with a capture member such as a chain, strap, buckle, or another similar mechanism to secure the shaft 20 in place. The cradle 120 may comprise steel, such as a steel beam. In some examples, as depicted below in FIGS. 7A-7C the cradle may comprise a material with an inverted “U” shaped cross section. In some examples, the upper portion of the cradle 120 may comprise a layer of material configured to pad the cradle and/or increase robustness of the cradle 120. In some examples, the material may comprise a polymer. In some examples, the material may comprise ultra-high molecular weight polyethylene (UHMW).

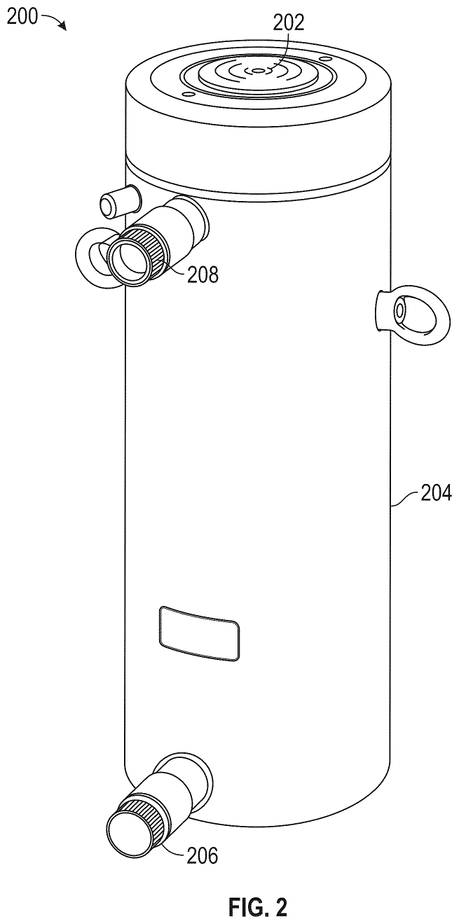

The shaft support assembly 100 may be used with a mechanical lifting device. In some examples the mechanical lifting device may be a hydraulic cylinder (also referred to as a “jack member”). FIG. 2 depicts a double-acting hydraulic cylinder 200, which can be used with an associated independent Hydraulic Power Unit (HPU), a control wand, and/or other means for controlling hydraulic cylinders. The hydraulic cylinder 200 can be positioned within the inner cavity of the insert portion 102 and extend along the axis of motion 101. The hydraulic cylinder 200 can convert hydraulic energy into linear motion and can comprise a ram 202 (also referred to as a “hydraulic ram”) and a main body 204. The ram 202 can be coaxial with and extend from the main body 204. The ram 202 may connect to the inside of the insert portion, for example, a bolt may extend through the hole 124 in the insert portion 102 and into the ram 202 coupling the insert portion 102 to the ram 202.

The hydraulic cylinder 200 can comprise two ports which couple with hydraulic lines and allow hydraulic fluid to act on either side of an internal piston, enabling it to extend and retract the ram 202. In some examples, a first port 206 can be configured to extend the ram 202 and a second port 208 can be configured to retract the ram 202. The hydraulic lines can run down the inner cavity of the insert portion 102 and can extend through the window 122. As depicted the first port 206 and the second port 208 extend straight out from the cylinder, however, the first port 206 and the second port 208 can also comprise an angle, for example a 90-degree angle which can have the advantage of reducing the space required for the hydraulic lines. In some examples, control of the hydraulic cylinder can be via a simple up/down button, allowing a user to easily adjust the height of each shaft support assembly 100 during the shaft extraction process. The ram 202 can extend and retract relative to the main body 204 along the axis of motion 101. In some examples the hydraulic cylinder is rated at greater than 75 tons, in some examples greater than 150 tons, in some examples greater than 300 tons. In some examples, the HPU power source can require a 460V, 3-phase, 60 Hz, max 16.5 amps power input.

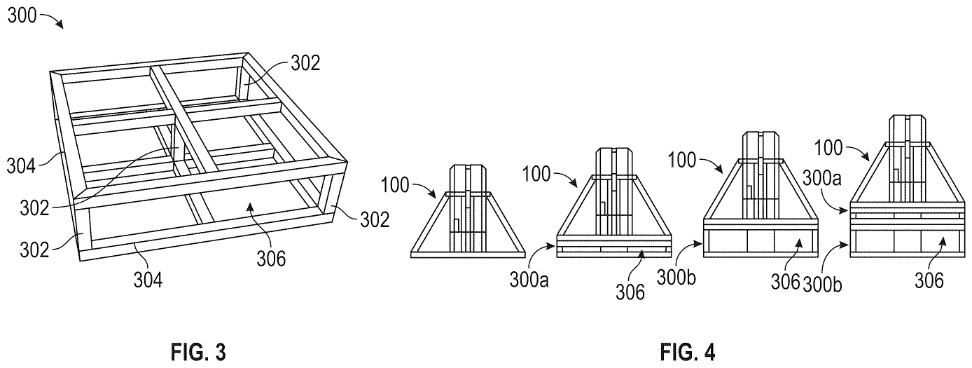

FIGS. 3-4 depict height adjustment stands which can be used to increase the height of a shaft support assembly, for example the shaft support assembly 100. In some examples, the stands can increase the height of the shaft support assembly 100 in increments in a range of 1 foot to 4 feet for each stand, in some examples in a range of 1 foot to 2 feet for each stand. FIG. 3 depicts an example of a stand 300 which can comprise vertical elements 302 and horizontal elements 304. The vertical elements 302 and or the horizontal elements 304 can comprise a rectangular solid, a rectangular hollow bar, or a similar shape. In some examples the vertical elements 302 and or the horizontal elements 304 can comprise steel. The vertical elements 302 and horizontal elements 304 can be coupled together such that they form a horizontally extending aperture 306 which is configured to receive forklift arms. In some examples, the stand 300 can have other attachment mechanisms such as one or more apertures for receiving eye hooks, attachment points, lifting eyes, or another similar lifting mechanism. The depicted height adjustment stand comprises horizontal and vertical elements, however in some examples a height adjustment stand can comprise diagonal elements in addition to, or in place of, of the horizontal elements or vertical elements.

FIG. 4 depicts examples of shaft support assemblies 100 positioned on height adjustment stands. The height adjustment stands 300a, 300b can be substantially similar to the height adjustment stand 300, for example the height adjustment stands 300a, 300b can comprise horizontal and vertical elements as well as horizontally extending apertures 306. The height adjustment stands depicted in FIG. 4 illustrate how a variety of different required heights can be achieved using height adjustment stands of different heights, for example, height adjustment stand 300a and height adjustment stand 300b. Additionally, a required height can be achieved by stacking two or more height adjustment stands, for example, by stacking height adjustment stand 300a and height adjustment stand 300b on top of one another. The height adjustment stands can be attached to one another and/or to the shaft support assembly 100 by permanent or semi-permanent connection, such as by welds, clamps, bolts, screws, pins, bands, straps, or other similar mechanisms.

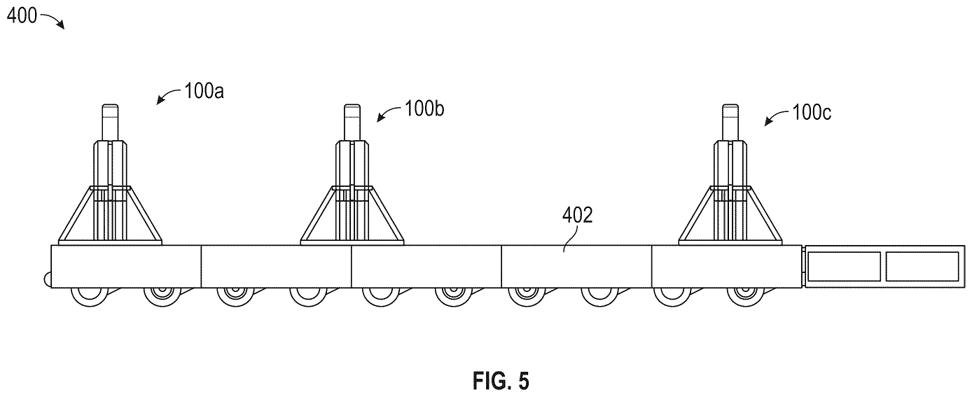

FIG. 5 depicts a system 400 for removing a propeller shaft from a ship. The system comprises a vehicle 402 configured to carry the weight of a propeller shaft and one or more shaft support elements which can be disposed along the length of the vehicle 402. In some examples, the vehicle comprises a self-propelled modular transporter (SPMT) (also referred to as a “self-propelled modular trailer”). The shaft support elements 100a, 100b, 100c can be sized and shaped for transport on single SPMT. The shaft support elements 100a, 100b, 100c can be individually moved with forklifts, for example the shaft support elements can be loaded onto the vehicle 402 or removed from the vehicle 402 with a forklift. The shaft support elements 100a, 100b, 100c can be secured to the vehicle using one or more chain hoists or come alongs, and/or other means for securing. In some examples the shaft support elements can be positioned on height adjustment stands as described above to achieve a predetermined height. In some examples, three shaft support elements positioned on the vehicle 402 allows for removal of different shaft types, including those with external struts, as will be detailed below.

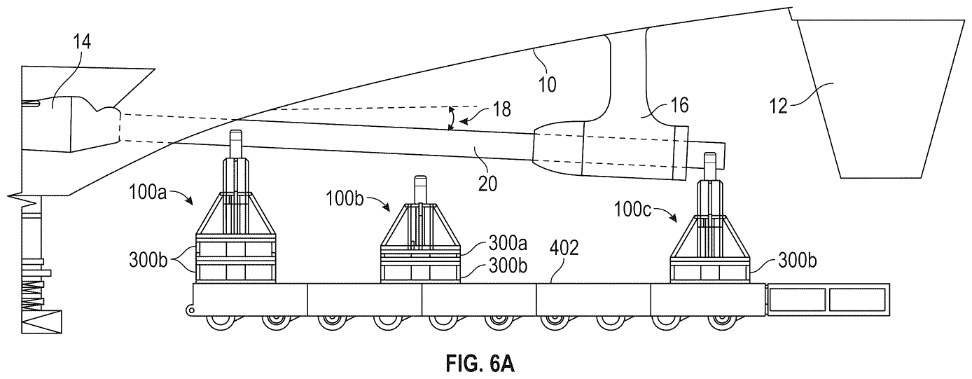

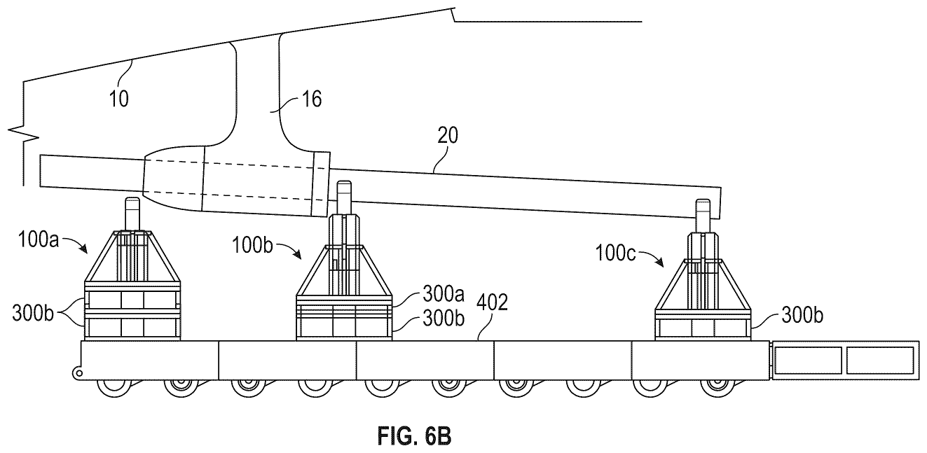

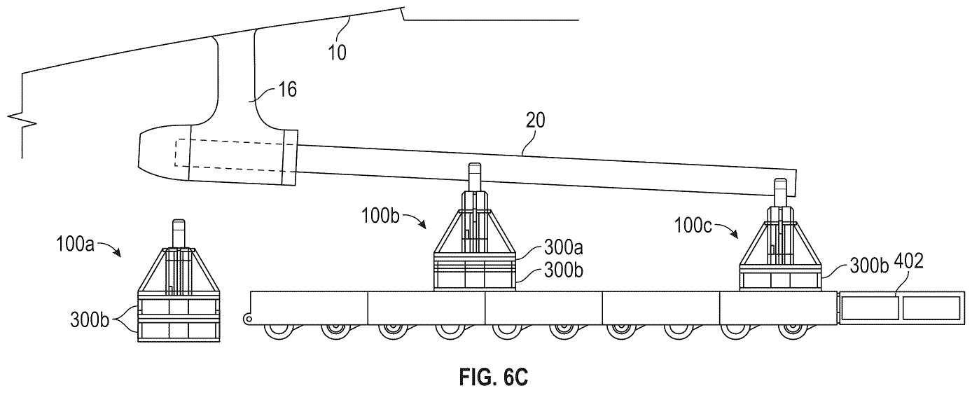

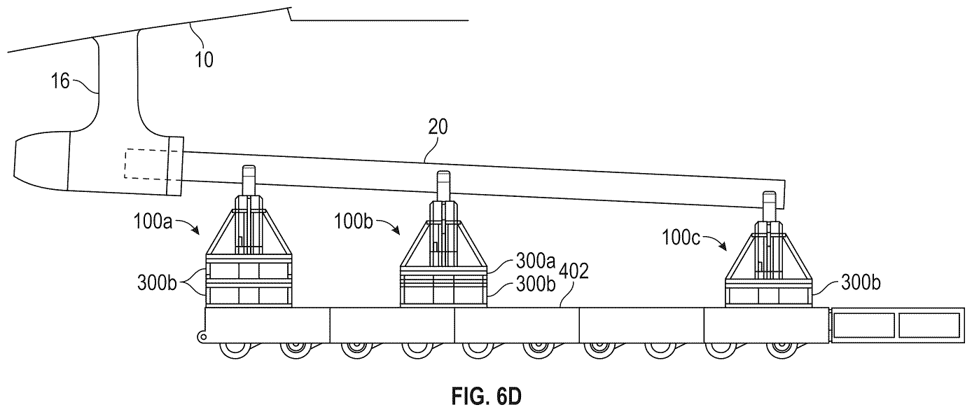

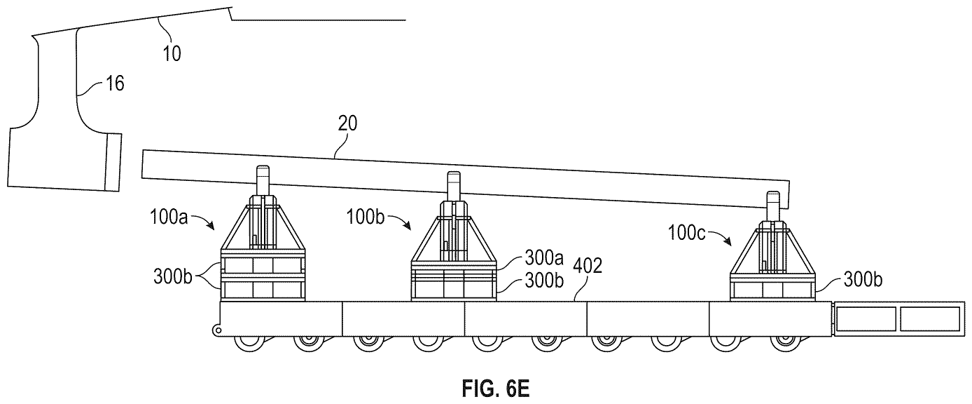

FIGS. 6A-6E depict a ship 10 with a propeller shaft 20, a rudder 12, and an external shaft strut 16 as well as a system for removing a propeller shaft from a ship. The propeller shaft 20 can be angled downward relative to horizontal by an angle 18 however, a similar process can be employed to remove a horizontally mounted propeller shaft and/or a propeller shaft that is internally mounted (i.e. a propeller shaft with no external strut). The system for removing a propeller shaft from a ship comprises a vehicle 402 with a first shaft support element 100a, second shaft support element 100b, and third shaft support element 100c disposed along the length of the vehicle 402. As depicted, the shaft support elements may be positioned on one or more height adjustment stands. The height adjustment stands can be similar to those depicted in FIGS. 3-4. In some examples, particularly when in use with an angled propeller shaft the height adjustment stands may be positioned to help match the downward slope of the angled propeller shaft. For example, the first shaft support element 100a may be positioned at a first height, the second shaft support element 100b may be positioned at a second height, and the third shaft support element 100c may be positioned at a third height. The first height may be larger than the second height and the second height may be larger than the third height. In some examples, the heights of the shaft support elements may be in another height order or the shaft support elements may all be positioned at substantially the same heights.

The rudder 12 is depicted in FIG. 6A but may be removed as a part of a separate process before the shaft 20 is withdrawn from the ship to make room for the shaft withdrawal procedure. The rudder 12 is depicted as removed in FIGS. 6B-6E. The depicted ship 10 has an angled propeller shaft 20 and an external strut, however, in some examples, ships can have a horizontal propeller shaft (i.e. a propeller shaft with no downward angle) and/or no external strut (i.e. ships with propeller shafts which are internally housed).

FIGS. 6A-6E depict the process of removing a propeller shaft 20 from a ship 10 with a downward angled propeller shaft 20 and an external strut 16. FIG. 6A depicts the propeller shaft 20 in an initial fully installed position. In this initial position, the propeller shaft 20 extends into an internal portion of the ship 10 and is supported by an internal support 14 (e.g. internal bearings) and an external strut 16. The first shaft support element 100a is positioned in an extended configuration such that it engages and supports the propeller shaft 20. The second shaft support element 100b is positioned in a retracted configuration such that it does not yet engage or support the propeller. The third shaft support element 100c is positioned in an extended configuration such that it engages and supports the propeller shaft 20.

In FIG. 6B, the propeller shaft 20 has been retracted such that it is free of the internal portion of the ship (i.e. the internal support 14). As a result of this retraction, the first shaft support element 100a is positioned proximal to the external strut 16. Once the first shaft support element 100a moves in the aft direction far enough that it reaches the external strut 16, the shaft is prevented from being retracted more while the first shaft support element 100a is engaged to the propeller shaft 20. The second shaft support element 100b is then extended so that it engages the propeller shaft 20 and the first shaft support element 100a is disengaged and lowered. At this point, the propeller shaft 20 is supported by the second shaft support element 100b and the third shaft support element 100c.

FIGS. 6C-6D depict the propeller shaft 20 as it is retracted from the ship 10. In some examples, the first shaft support element 100a may be removed from the vehicle 402 in order to provide sufficient clearance for the vehicle 402 to pass under the external strut 16. In some examples, as depicted in FIG. 6D, the first shaft support element 100a may be placed back on the vehicle 402 once the propeller shaft 20 has been retracted to a predetermined position.

FIG. 6E depicts the propeller shaft 20 fully removed from the ship 10 and supported by the first shaft support element 100a, the second shaft support element 100b, and the third shaft support element 100c. In some examples, the propeller shaft 20 can then be leveled and/or transported to another location using the vehicle 402.

FIGS. 7A-7C depict aspects of a shaft support assembly 500 for removing a propeller shaft from a ship according to another example. The shaft support assembly 500 can be the same as the shaft support assembly 100 except for the differences described below. For example, the shaft support assembly 500 can comprise an insert portion 502 and a frame portion 504. The frame portion 504 can comprise a base portion 506 disposed around the axis of motion 501 and four struts 508 which are coupled between the base portion 506 and a first support portion 510. However, the shaft support assembly 500 need not include all of the components described above for the shaft support assembly 100. One or more of the shaft support assemblies 500 can be used as a part of a system for removing a propeller shaft from a ship, for example the shaft support assemblies 500 can be used in place of the shaft support assemblies 100 with the system 400 as described above.

The frame portion 504 may comprise one or more inwardly facing mating elements disposed between the first support portion 510 and the second support portion 512. In the depicted example, rails 514 are disposed at the four corners of the first support portion 510 and the second support portion 512. Placement of the rails 514 at the corners of the first support portion 510 and the second support portion 512 may have the advantage that the insert portion 502 does not require mating elements disposed on the radially outward facing portion of the insert portion 502. As depicted, he frame portion 504 may comprise one or more lifting points, such as lifting lugs 526. In some examples, the lifting points may comprise lifting eyelets, lifting rings, or another permanent or semi-permanent fixture meant for attaching a chain or other rigging.

In the depicted example, the rails comprise a layer of material 515 configured to reduce friction and/or increase robustness between the rails 514 and the insert portion 502. In some examples, the material 515 may comprise a polymer. In some examples, the material 515 may comprise UHMW.

An insert portion 502 can be configured to slide along an axis of motion 501 within the frame portion 504. A hydraulic cylinder, such as hydraulic cylinder 200 can be positioned within an inner cavity of the insert portion 502 and the hydraulic lines can extend through a window (not shown) similar to window 122 in the insert portion 102.

In some examples, it may be desirable to be able to adjust the position of a cradle portion 520. In the depicted example, the insert portion 502 comprises a cradle adjustment portion 550 coupled to the top of the insert portion 502 and a cradle 520 is coupled to the adjustment portion 550. The cradle 520 can be configured to receive and support a propeller shaft 20. The cradle 520 may comprise steel, such as a steel beam. As depicted in FIGS. 7A-7C the upper portion 521 of the cradle 520 may comprise a layer of material configured to pad the cradle and/or increase robustness of the cradle 520. In some examples, the material may comprise a polymer. In some examples, the material may comprise UHMW.

The adjustment portion 550 can allow the cradle 520 to rotate about a rotational axis 551 and/or to translate in a direction parallel to the axis 551. In some examples, the axis 551 may be orthogonal to the axis of motion 501. The adjustment portion 550 can comprise a lead screw 552, one or more shoulder portions 554, one or more first cradle supports 556, one or more second cradle supports 562, a wall portion 559, a lip portion 558, and a carriage 564. The rotation and/or translation of the cradle 520 can have the advantage of better positioning the cradle 520 to receive a propeller shaft. For example, one or more of the shaft support assemblies 500 can be placed on a vehicle and positioned as close as possible to alignment with the propeller shaft, then the adjustment portion 550 can be used to provide a fine tune adjustment of the position of the cradle 520. This can allow for greater alignment accuracy and reduce the need for repositioning the vehicle and/or repositioning the shaft support assemblies 500 on the vehicle, which can save time for the users.

In some examples, the adjustment portion 550 allows the cradle 520 to rotate about the rotational axis 551 as depicted by the arrow 540. This rotation can have the advantage of better receiving an angled propeller shaft (such as the propeller shaft 20 described above) within the cradle 520. FIG. 7C depicts the adjustment portion with the cradle 520, the wall portion 559, and the lip portion 558 removed. As depicted, the cradle 520 (FIGS. 7A-7B) can be supported on each side by the first cradle support 556 and the second cradle support 562 which are coupled to one another by a pin 560. The first cradle support 556 and the second cradle support 562 are pivotably coupled to the shoulder portion 554 by the pin 560 which defines the axis 551. The cradle 520 is free to rotate about the pins 560, and the axis 551, a predetermined amount from the axis of motion 501. In some examples, the rotation, measured from the axis of motion 501, can be 30 degrees in either direction. In some examples, the rotation, measured from the axis of motion 501, can be 20 degrees in either direction. In some examples, the rotation, measured from the axis of motion 501, can be 10 degrees in either direction.

In some examples, the adjustment portion 550 allows the cradle 520 to translate parallel to the axis 551 as depicted by the arrow 542. This translation can have the advantage of helping to better align the cradle with the propeller shaft without the need for repositioning the shaft support assembly 500. When in use with a system comprising more than one shaft support assemblies, such as the system 400, the ability to position each cradle 520 laterally can assist in lining up the cradles of the one or more shaft support assemblies along the propeller shaft. FIG. 7C depicts the adjustment portion with the cradle 520, the wall portion 559, and the lip portion 558 removed. The cradle 520 (FIGS. 7A-7B) can be supported on each side by the first cradle support 556 and the second cradle support 562 and can also be coupled to the carriage 564. The carriage 564 can have a through hole with internal threads which can be threadedly coupled with the external threads 566 on the lead screw 552. The lead screw can pass through holes 553 in the shoulder portions 554 and be supported by the wall portion 559 (FIGS. 7A-7B). When the lead screw 552 is rotated, it causes the carriage 564 to move in a lateral direction parallel to the axis 551. The carriage 564 is coupled to the cradle 520 which is coupled to the first cradle supports 556 and the second cradle supports 562 and all move as a unit when the lead screw 552 is rotated. In some examples, the cradle 520 can move laterally 1 to 6 inches in either direction from a center portion of the lead screw. In some examples, the cradle 520 can move laterally 1 to 3 inches in either direction from a center portion of the lead screw. In some examples, the cradle 520 can move laterally 1 inch in either direction from a center portion of the lead screw.

The shaft support apparatuses described above can be easy to use and require little maintenance which can save time and money. They can also improve the safety of the propeller shaft removal process. The design of the apparatuses described herein means that they can have the advantages of being low cost to construct and easy to maintain. The apparatus described herein can be modular and easily movable using machinery already available in a shipyard environment, for example, forklifts.

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. A shaft support assembly for removing a propeller shaft from a ship, the shaft support assembly comprising:
a vertical axis of motion;
a jack member disposed along the vertical axis of motion and comprising a main body and a hydraulic ram, wherein the hydraulic ram extends along the vertical axis of motion;
an insert portion coupled to the hydraulic ram and extending over the jack member when the ram is in a retracted position within the main body;
a lead screw coupled to an upper side portion of the insert portion and disposed along a translation axis, wherein the translation axis is orthogonal to the vertical axis of motion;
a cradle disposed on the lead screw wherein the cradle is configured to move laterally on the lead screw along the translation axis; and
a frame disposed around the insert portion and the jack member and configured to support the insert portion, wherein the frame comprises a base portion, a first support portion which extends around the insert portion and is spaced from the base portion along the vertical axis of motion, and a plurality of inwardly angled struts which extend between the base portion and the first support portion,
wherein the insert portion and the frame are configured to protect the jack member from lateral loading during relative motion between the insert portion and the frame.

2. The shaft support assembly of claim 1, further comprising a second support portion positioned radially inward from the base portion and substantially coplanar with the base portion wherein the insert portion has radially externally facing mating features and wherein the frame has radially internally facing mating features comprising rails fixed between the first support portion and the second support portion which are configured to receive the radially externally facing mating features of the insert portion.

3. (canceled)

4. The shaft support assembly of claim 1, further comprising a lip portion coupled to the upper side of the insert portion, wherein the cradle is configured to rotate about a rotational axis, wherein the rotational axis is orthogonal to the vertical axis of motion, and wherein the lip portion is configured to partially restrict rotation of the cradle.

5. (canceled)

6. A system for removing a propeller shaft from a ship, the system comprising:
one or more shaft support assemblies of claim 1; and
a self-propelled modular transporter (SPMT) configured to carry a propeller shaft, wherein the one or more shaft support assemblies are disposed along a length of the SPMT.

7. (canceled)

8. (canceled)

9. A shaft support assembly for removing a propeller shaft from a ship, the shaft support assembly comprising:
an axis of motion;
an insert portion configured to be coupled to a mechanical lifting device and to extend over the mechanical lifting device when the mechanical lifting device is in a retracted position;
a cradle coupled to an upper side portion of the insert portion, wherein the cradle is configured to rotate about a rotational axis, wherein the rotational axis is orthogonal to the axis of motion, and wherein rotation of the cradle about the rotational axis is limited to 30 degrees in either direction from the axis of motion; and
a frame disposed around the insert portion and configured to support the insert portion, wherein the frame comprises a base portion, a first support portion which extends around the insert portion and is spaced from the base portion along the axis of motion, and a plurality of inwardly angled struts coupled to the base portion and the first support portion to form a pyramid shape, and wherein the insert portion and the frame are configured to protect the mechanical lifting device from lateral loading during relative motion between the insert portion and the frame.

10. The shaft support assembly of claim 9, further comprising a second support portion positioned radially inward from the base portion and substantially coplanar with the base portion wherein the insert portion comprises radially externally facing mating features comprising projections and wherein the frame has radially internally facing mating features comprising rails extending between the first support portion and the second support portion and forming slots which are configured to receive the radially externally facing mating features of the insert portion.

11. The shaft support assembly of claim 9, further comprising the mechanical lifting device disposed within an internal cavity of the insert portion and disposed along the axis of motion.

12. (canceled)

13. The shaft support assembly of claim 9, further comprising a cradle coupled to the insert portion.

14. The shaft support assembly of claim 13, wherein the cradle is configured to rotate about a rotational axis, wherein the rotational axis is orthogonal to the axis of motion.

15. The shaft support assembly of claim 13, wherein the cradle is configured to move laterally along a translation axis, wherein the translation axis is orthogonal to the axis of motion.

16. A method for removing a propeller shaft from a ship, the method comprising:
positioning a self-propelled modular transporter (SPMT) under a propeller shaft, wherein the SPMT comprises a first shaft support assembly and a second shaft support assembly and wherein the SPMT is capable of multi directional positioning of the first shaft support assembly and the second shaft support assembly;
attaching the first shaft support assembly and the second shaft support assembly to the propeller shaft; and
retracting the propeller shaft by moving the first shaft support assembly and the second shaft support assembly in a direction which withdraws the propeller shaft from the ship.

17. The method of claim 16, further comprising attaching a third shaft support assembly to the propeller shaft and disengaging the first shaft support assembly.

18. The method of claim 17, further comprising withdrawing the propeller shaft from an external strut after disengaging the first shaft support assembly.

19. The method of claim 16, further comprising using the first shaft support assembly and the second shaft support assembly to position the propeller shaft as required while withdrawing the propeller shaft from the ship.

20. The method of claim 16, further comprising using an adjustment portion to adjust a position of a cradle portion before attaching the first shaft support assembly and the second shaft support assembly to the propeller shaft.

21. The shaft support assembly of claim 1, wherein the base portion has a lateral dimension greater than a lateral dimension of the first support portion.

22. The shaft support assembly of claim 2, wherein the insert portion comprises four sides with a projection on each side, and the frame comprises four corresponding radially inward mating features.

23. The shaft support assembly of claim 2, wherein the radially inward mating features comprise eight rails fixed between the first support portion and the second support portion.

24. The shaft support assembly of claim 2, wherein radially internally facing mating features comprises four rails fixed between the first support portion and the second support portion at corners of the first support portion and the second support portion.
